(19) United States
(12) Patent Application Publication
(10) Pub. No.: US 2003/0043990 A1
(43) Pub. Date: Mar. 6, 2003

(54) Method and system for putting a telephone call on hold and determining called party presence

(75) Inventors: Srinivas Gutta, Buchanan, NY (US); Antonio Colmenarez, Peekskill, NY (US); Miroslav Trajkovic, Ossining, NY (US)

Correspondence Address: KONINKLIJKE PHILPS ELECTRONICS N. V., 580 WHITE PLAINS RD., TARRYTOWN, NY, 10591, US

(73) Assignee: Koninklijke Philips Electronics N.V.

(21) Appl. No.: 09/946,950

(22) Filed: Sep. 5, 2001

(51) Int. Cl. H04M 3/42

(52) U.S. Cl. 379/215.01

(57) ABSTRACT

When a call is placed to an organization seeking information from a representative of that organization, the call is frequently placed on hold for an extended period of time. After the call is made and the called party's telephone is placed on hold, the caller enters a code signal to place the call on hold. At this instant, both telephones are on hold. At some time after this “Hold On Hold” connection is established when a representative of the organization called answers the telephone and speaks to identify himself, the network identifies the signals as being generated by a live person, and a ring signal is sent to the caller's telephone to alert the caller that the call is no longer on hold.

### CROSS REFERENCE TO RELATED APPLICATION

Related subject matter is disclosed in the following application assigned to the same assignee hereof: U.S. patent application, Ser. No. 09/893,260, filed Jun. 27,2001.

### BACKGROUND OF THE INVENTION

1. Field of the Invention

This invention relates to a communication system and more particularly to method and system for putting a calling party's telephone on hold and determining at the calling party's telephone the presence of the called party.

2. Description of the Related Art

Various organizations use different processes for routing received calls to individuals of various departments. In one example where a small office has a number of telephone extensions that connect with a switchboard, an operator receives an incoming call and inquires who the caller wishes to speak with. The operator then connects the call to the extension of the desired recipient. If the recipient is not at his or her desk, the operator may page the recipient and, if the recipient responds from another extension in the office, the operator will route the call to the new extension. In those instances where the recipient is not at his/her assigned extension, the caller is placed on hold while a search is made by the operator. When the caller is placed on hold, it will be with or without background music until the called person is located or the operator returns to report that the called person is not available.

In another example, an incoming call may be routed to an extension of a desired recipient in an office or other location via an automated routing system, such as a Private Branch Exchange (PBX) system. In such a system, after the call is answered, the caller is prompted via an automated response system to input the name or extension of the desired recipient, or a number in response to a menu of specific questions or topics. The system then routes the call to the selected extension of the recipient or to an extension phone number which is connected to multiple phones where each phone is serviced by an individual. One such instance is where a person calls, for example, the Internal Revenue Service (IRS), selects a number from a menu of topics which most closely fits his/her question, and is told by an automated voice response that his/her call will be answered by the next available representative. In some instances there will be background music (often referred to as music on hold), voice advertisements or messages, or there will be silence. Some time thereafter, an automated voice message will report that the next available representative will be available in approximately 10 minutes (for example), and that the caller should not hang up and call back as the waiting time for the second call could be longer. In this instance, during the waiting period, there may be music on hold, voice messages or silence. The automated voice will return periodically during the hold period to report that all representatives are still busy. During this announcement the music may be muted or continue as background music and, where the music is continuous, the voice message will override the music. Other instances where callers are put on hold occur where the called person must leave the phone to search for the information requested, consult with a third person, seek advice from a manager or the like.

Thus, when a call is placed to an organization, the caller is often placed on hold until a representative becomes available and, in many instances, the duration of the hold interval may be unreasonably long. In some instances, i.e., a call to the IRS, E-ZPass or other large organizations, the caller may be on hold for twenty or more minutes. Thus, the caller will continuously hold the phone to listen for a response or activate the speaker phone to avoid missing the representative. In addition, the need for the caller to remain in the room near the phone for the duration of the hold period can be an additional burden. Clearly, a need exist for a method and/or a system for relieving a caller of the burden of being tied to a telephone while waiting for a called representative to take the called telephone off “hold” and provide the information sought.

### SUMMARY OF THE INVENTION

Often, when a call is placed to an organization for information from a representation of that organization, the call is placed on hold for an extended period of time which can approach 20 or more minutes. The caller, because he/she is on hold and, therefore, cannot speak to any one at the called telephone, must continuously hold the telephone to his/her ear or activate the speaker phone to avoid missing the representative when the representative eventually picks up the call. In either case, the caller must remain proximate the telephone. The method and apparatus here disclosed solves this problem. Immediately after a call is made and the called party's telephone is placed on hold because a representative in not available to answer the telephone, the caller enters a code signal which puts the caller's telephone on hold. At this instant, both telephones are on hold. This connection is a totally new type of connection and is here referred to as “Hold On Hold”. At some time after the Hold On Hold connection is established by the caller, a representative of the organization called answers the telephone. At this instant, the called telephone is no longer on hold. As soon as the representative speaks into the telephone to identify himself/herself, the network identifies the received signals from the called telephone as being generated by a live person, and a ring signal is sent to the telephone from which the call was made, or to a nearby or associated extension, to alert the caller that the called telephone is no longer on hold and that a person is at that telephone.

### BRIEF DESCRIPTION OF THE DRAWINGS

In the drawings:

FIG. 1 is a block diagram of structure in accordance with the principles of the invention; and

FIG. 2 is a flow diagram of a method in accordance with the principles of the invention.

### DETAILED DESCRIPTION OF THE PRESENTLY PREFERRED EMBODIMENTS

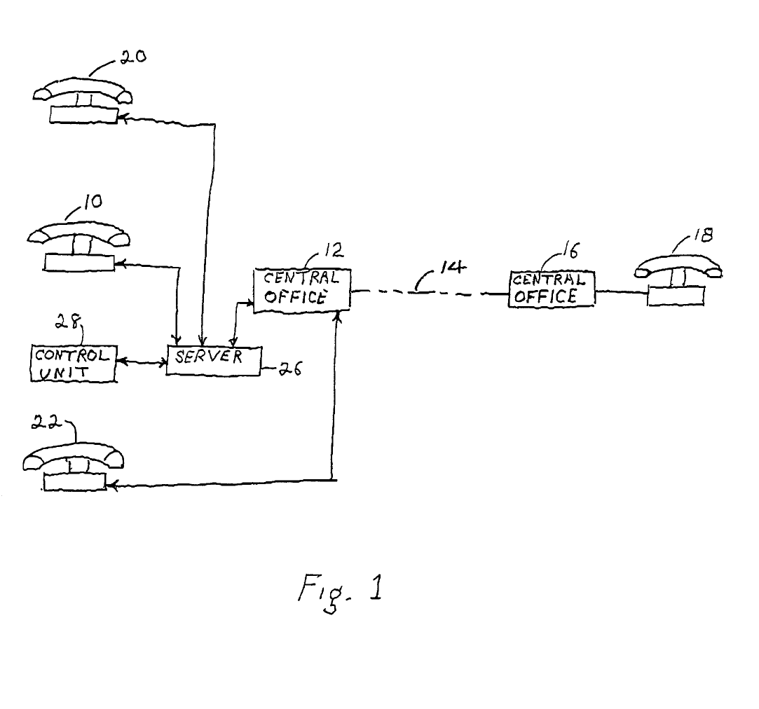

Referring to FIG. 1, a person located at a telephone 10 places a call to an organization such as, for example, a customer service department of a credit card company located at telephone 18. The call goes from telephone 10 to the calling party's central office 12, then over land lines 14 to central office 16 which routs the call to the telephone 18, the number called. Telephone 20 represents a telephone located in the same building as telephone 10 but answers to a different extension number. Telephone 22 can represent a telephone at a different location and has a different number, but is connected to the same central office 12. A server 26 which may be interposed between central office 12 and telephones 10, 20 may, for convenience, be located within or proximate the building that houses telephones 10, 20. The operation of the server 26 will be explained in detail below. Server 26 is normally passive for calls to and from telephones 10, 20. More specifically, server 26 is transparent to calls from and to telephones 10, 20 until activated by an activation code such as ☆17 which is input by the telephone making the call such as telephone 10 or 20.

In the embodiment here disclosed, a caller, using telephone 10 calls the number of the customer service department which, in this instance, is telephone 18. The call from telephone 10 passes through server 26, which is assumed to be in its passive state, to central office 12. Central office 12 directs the call to central office 16, which directs the call to telephone 18. Upon completion of the circuit, telephone 18 “rings” and is answered by an automated answering machine. Immediately thereafter, a message consisting of a menu of subjects where each subject is identified by a discrete number, i.e., 1, 2, 3, 4, is recited by the automated answering machine. The call from telephone 10 to telephone 18 is a completed call but the caller is not directly connected to telephone 18 nor can the caller yet talk to a live representative of the consumer service department. The automated menu takes control and may recite a message such as “Thank you for calling . . . ” and then recites a menu of subjects each of which normally requires a response which is provided by asking the caller to press a numbered key on the telephone keypad.

The subjects are options for the caller to select, such as “to hear your current outstanding balance, press 1”; “to hear your last payment, press 2” or “to speak to a representative, press 4”.

In this example, it is assumed that the caller selects option 3 by depressing button 4 on the keypad of telephone 10. Because, at any instant, there are normally more calls being received by the consumer service department than there are representatives to answer the incoming calls, after button 4 is pressed, the caller is connected to “music on hold”, and the music on hold is continuous until a live representative answers the telephone. At various intervals throughout the hold period, vocal messages may be heard. The messages may, for example, alternate between a female voice and a male voice and they will be heard over the music. The music is continuous and is not interrupted by the voice messages. At some time, which may be as long as 20 minutes after the call is initiated, a representative will pick up telephone 18 to talk to the caller at telephone 10.

With the invention here disclosed, immediately after selecting option 4 (talk to a representative), the caller activates server 26 by pressing a unique set or preprogrammed buttons on the telephone keypad such as, for example ☆17 and then hangs up the telephone. Server 26 puts the caller's telephone 10 on hold, which allows the caller at telephone 10 to hang up the handset without actually disconnecting the call. Thereafter, when the called representative of the customer service department does pick up the telephone to answer the call, the caller's telephone from which the call was initially made will ring to alert the caller that an actual person is now on the line.

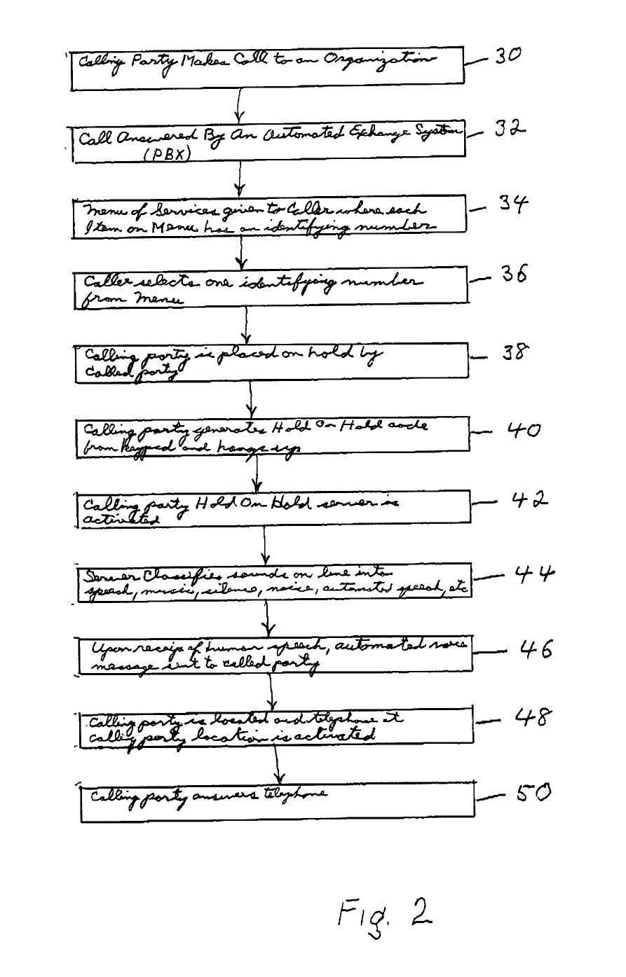

Referring to FIG. 2 there is illustrated a flow chart in accordance with the principles of the invention. In the specific example noted previously, a caller initiates a call to an organization such as a customer service department of a credit card company, step 30. The call is received by the telephone at the consumer service department and answered by an automated answering machine, step 32, not by a live person. The automated answering machine sends a voice message back to the calling party which is a menu of subjects where each subject is identified by a discrete number, step 34. The caller selects one of the subjects by pressing the number associated with that number. In this example, the caller pushes button No. 4 on the telephone keypad, step 36. Upon completing step 36 by pressing button 4, the telephone of the calling party is placed on hold, step 38.

At some time thereafter the calling party, not wishing to hold his telephone for the duration that the called telephone is on hold, pushes a unique activation button sequence on his telephone keypad (such as the buttons ☆17) to activate the Hold On Hold (HOH) program of this invention and then hangs up his handset, step 40.

Pressing the unique activation button sequence or code (☆17) initiates the activation of server 26 which places the call on hold without disconnecting the call. Server 26 may be located at the calling party's location, or it can be located at the service provider premises. Server 26 is in its inactive or passive state until activated by the Hold On Hold activation code. In its passive state, the server 26 is transparent to all signals to and from the calling party which pass through the server 26 as though the server 26 is not in the network. Upon activation, the server 26 performs multiple functions of classifying audio segments into discrete categories more fully identified as being, for example: silence, single speaker speech, music, environmental noise, multiple speakers' speech, simultaneous speech and music, and speech and noise. The environmental noise category refers to noise without foreground sound. The simultaneous speech and music category includes both singing and speech with background music.

Structure which performs the functions of server 26 is disclosed in the publication by Li, Sethi, Dimitrova and McGee “Classification of General Audio Data for Content-Based Retrieval”; Pattern Recognition Letters 22 (2001) pp. 533-544, the contents of which are hereby incorporated by reference. This publication is directed toward the classification of continuous general audio data for content-based retrieval, and describes a scheme that is able to classify audio signals into the above itemized categories. As explained it the publication, to make the task of feature evaluation easier, an audio toolbox was developed for feature extraction. The classifier parses a continuous bit-stream of audio data into different non-overlapping segments such that each segment is homogenous in terms of its class. Since the transition of audio from one category into another can cause classification errors, a segmentation-pooling scheme is suggested as an effective way to reduce such errors.

The publication is organized into five sections where Section 2 describes the auditory toolbox and the extraction of features. Section 3 presents the framework for the classification of continuous General Audio Data. Section 4 contains a comparison of different sets of features and the evaluation of the suggested system is given in Section 4. Summarizing remarks and applications are presented in Section 5. As stated in Section 5 of the publication, an audio classification system which is able to classify audio segments into seven categories is presented. With the help of the auditory toolbox disclosed therein, a total of 143 classification features were tested and compared. The publication discloses a segmentation-pooling scheme as an effective way to reduce the border effect and to generate classification results that are consistent with the human perception. Experimental results show that the classification system disclosed in the publication provides about 90% accurate performance with a processing speed that is substantially faster than the playing rate.

After the server is actuated, the telephone call is placed on hold. The server now does what the calling party would normally do that of: listening to the audio information that is being received from the called party and classifying the received information into various categories of silence, single speaker speech, music, simultaneous speech and music, etc., step 44. At some time during the Hold On Hold period, a representative of the consumer service department picks up the telephone of the called line and start to speak. The first few words will probably be an identifying phrase such as “I am Mr./Mrs. . . . ”,or “My name is . . . ”, Or “I apologize for the wait, my name is . . . ”, etc. The server, upon receiving and analyzing the received signals, identifies the speech as being from a live person by using speech recognition technique that are common in the art. For example, the server, upon detecting a specific group of words such as “my name is” or “my number is” identifies the received information as coming from a live person. In other instances, a tone may be the indicator that a live person is now on the line. Immediately the server sends a ring signal to telephone 10 to alert the caller that a live representative is on the line. In addition, the server may optionally send a generated voice message back to the called party (here, the customer service department representative) with a request such as “Please hold for a moment while the person who called you picks up the phone”. In another embodiment, the calling party, while waiting for a response, may have gone to another office in the same building which has a different telephone 20 (see FIG. 1). In this embodiment, server 26 communicates with control unit 28 which determines whether the caller is at the telephone from which the call was made or has relocated to a new location. If the caller has moved to a new location and has so informed the control unit 28, the server then sends a ring signal to the new telephone 20 at the new location to alert the caller that a person is on the called telephone. If the caller has not relocated, control unit 28 reports this to the server and the server sends a ring signal to telephone 10, the telephone from which the call was made. Alternatively, the control unit 28 may sense where the caller is currently located and reroute the call to the callers present location. A system and method for providing automatic routing of calls in a local environment is disclosed in U.S. patent application, Ser. No. 09/893,260 titled “Intelligent Phone Ringer” which is incorporated herein by reference. Patent application Ser. No. 09/893,260 discloses that image detection and processing and/or voice detection in various locations and voice processing can be utilized to identify an individual and determine his/her location. It also discloses automatic detection of the location of a particular user in a local environment and automatic routing of a call for the particular user to the nearest telephone extension; and, additionally, automatic detection of the location of a particular user in a local environment using image recognition and/or voice recognition.

More specifically, routing and detection is achieved with a system that is comprises a control unit that receives images associated with two or more regions of a local environment. The two or more regions are each serviced by a respective telephone extension. The control unit processes the images to identify, from a group of known persons associated with the local environment, any one or more known persons located in the respective regions. For each known person so identified, an indicium is generated that associates the known person with the respective region in which the known person is located. An incoming call is switched by the server, which is controlled by the control unit, to at least one of the respective telephone extensions in which at least one detected person is located.

Referring to FIG. 2, and to the example where the caller has relocated from telephone 10 to telephone 20, the control unit 28 having determined that the caller has moved from telephone 10 to telephone 20, directs server 26 to send a ring signal to telephone 20, step 48. At this instant, the calling party picks up the telephone and talks to the representative at telephone 18, step 50.

Although the invention has been described in connection with telephone handsets 10, 20, 22, one or more of these units may be mobile telephones.

Thus, while there has been shown and described the fundamental novel features of the invention as applied to a preferred embodiment thereof, it is to be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, that this invention is to be limited only as indicated by the scope of the claims appended hereto.

What is claimed is:

1. A system for placing a telephone call initiated from a first telephone to a second telephone comprising:
control means to condition the first telephone to place on hold a call made from the first telephone; and
monitor means to determine that the occurrence of live speech on the line to the first telephone is from a live person; and
alerting means to energize the first telephone when the monitor means determines that live person speech is on the line.

2. The system of claim 1, wherein the call from first telephone is placed on hold after the second telephone has been placed on hold.

3. The system of claim 1, wherein the first telephone remains on hold until the second telephone is no longer on hold.

4. The system of claim 3, wherein the alerting means are coupled to send a ring signal to the first telephone after the second telephone is no longer on hold.

5. The system of claim 4, wherein the alerting means initiates the sending of the ring signal to the first telephone subsequent to detection by the alerting means of speech on the line.

6. The system of claim 5, wherein the speech on the line is that of a live person.

7. The system of claim 3, further comprising classifying means to classify signals on the line representative of audio segments into discrete categories.

8. The system of claim 7, wherein the discrete categories which can be classified include live single speaker speech.

9. The system of claim 7, wherein the discrete categories which can be classified include live single person speech from other categories.

10. The system of claim 7, wherein other categories that can be classified comprise simultaneous speech and music, silence, music.

11. The system of claim 7, wherein other categories that can be classified comprise multiple speakers' speech, speech and noise.

12. The system of claim 2, further comprising video processing means coupled to receive images associated with two or more regions of a local environment, the two or more regions each being serviced by a respective telephone extension, the video processing means adapted to identify, from a group of known persons associated with the local environment, any one or more known persons located in the respective regions and, for each known person so identified, generate an indicium that associates the known person with the respective region in which the known person is located for identifying a specific person with a specific telephone.

13. The system of claim 11, further comprising two or more cameras that provide images associated with the two or more regions of the local environment, each region having associated there with at least one of the two or more cameras, wherein images captured by the at least one camera associated with each region are processed to identify any known person located in the respective region.

14. The system of claim 13, wherein the indicium generated by the video processing is incorporated in a signal for each known person identified and associated with the respective region in which the known person is located.

15. The system of claim 13, further comprising a private branch exchange (PBX), wherein the signal is output by the control means to the PBX.

16. The system of claim 15, wherein for each known person identified, the PBX uses the signal to create a record that associates the known person with the telephone exchange servicing the respective region in which the known person is located.

17. A method for controlling a telephone connection between a call from a first telephone to a second telephone comprising the steps of:
establishing a telephone connection between the first telephone from which a call is made and the second telephone to which the call is made,
generating a signal from the second telephone to place the telephone call at the second telephone on hold,
generating a signal to place the call from the first telephone on hold subsequent to the telephone call at the second telephone having been placed on hold,
analyzing signals on the line for classifying signals representative of audio segments into discrete categories for energizing the first telephone to indicate the occurrence of speech from a live person is on the line.

18. The method of claim 17, wherein the discrete categories distinguishes between a person speaking and other audio signals.

19. The method of claim 17, wherein the discrete categories distinguishes between speech of a live person and other audio signals.

20. A method of controlling a call between a first telephone and a second telephone where a call from the first telephone has been received by the second telephone comprising the step of:
placing the first telephone on hold after the second telephone has been placed on hold, and
sending a signals to the first telephone to indicate when the first telephone is no longer on hold.

21. The method of claim 20, further comprising the step of sending a ring signal to the first telephone to indicate when the second telephone is no longer on hold.

22. The method of claim 22, further comprising the steps of sending the ring signal to a telephone other than the first telephone.
